(19) United States
(12) Patent Application Publication
(10) Pub. No.: US 2011/0265941 A1
(43) Pub. Date: Nov. 3, 2011

(54) On Site Manufactured Self Expanding Tubulars and Method

(75) Inventors: Dennis G. Jiral, Katy, TX (US); Mark K. Adam, Houston, TX (US); Darin H. Duphorne, Houston, TX (US)

(73) Assignee: BAKER HUGHES INCORPORATED, Houston, TX (US)

(21) Appl. No.: 12/770,218

(22) Filed: Apr. 29, 2010

(51) Int. Cl. B29C 53/08

(52) U.S. Cl. 156/203

(57) ABSTRACT

Tubular is manufactured at a well site to a predetermined size using flat stock that is rolled into a c-shape from a plurality of feed locations. The c-shapes have open segments that are offset from each other to form the tubular shape. A binder material such as a reactive nano-foil is applied on assembly as the tubular shape is formed. The manufactured shape is reduced to a smaller dimension for run in. The cross-sectional reduced profile shape can be a smaller diameter or a crescent or an undulating shape that is triggered to revert to the original manufactured shape and size when placed downhole. The manufacturing method is capable of making continuous pipe for the length of the zone without connections. The bonding of the segments is preferably done at the time of fabrication at the well site but can also occur at least in part downhole.

### FIELD OF THE INVENTION

The field of this invention is self expanding self expanding tubulars and a method for onsite manufacturing of self expanding self expanding tubulars.

### BACKGROUND OF THE INVENTION

Screens and tubulars for use as patches or connectors or for other downhole applications have been in use to take advantage of a material that can be installed while in a smaller dimensional configuration and can then, when positioned in a subterranean location, be triggered to assume an enlarged configuration. In some applications, the tubular has slits or slots that open when triggered to allow flow through the wall or in other cases to act as a screen or filter. These applications have also been combined in intelligent completions. Illustrative of such applications are the following patents assigned to Schlumberger: U.S. Pat. Nos. 7,398,831; 7,234,533; 7,222,676; 7,185,709; 7,182,134; 7,168,486; 7,156,180; 7,131,494; 7,104,324; 7,048,052; 6,848,510; 6,817,410; 6,799,637; 6,789,621; 6,772,836; 6,719,064 and 6,648,071.

Reactive foils have been used to connect metals to each other. Some of these materials have been developed by Reactive Nano Technologies now owned by Indium Corporation whose Web site is http://www.rntfoil.com/site/applications. Related US patents and applications are: U.S. Pat. Nos. 7,143,568; 7,121,402; 20070235500; 20050142495; 20040247930; 20040151939 and 20040149813.

Tubulars have been provided in coiled form in the past to save time at a well site and allow elimination of most connections for a given zone. The tubing comes on large coils on the back of specially equipped trucks and is unspooled into a well continuously. The capacity of such coil trucks is limited as they need to travel over roads to get to the well site. There are also limits to the degree of bending that the tubing can withstand to even get it onto a spool. As the diameter increases the capacity of a given spool decreases. If the diameter is large enough or the well is deep enough a point is reached where it is not practical to use coiled tubing.

The present invention addresses this issue by providing a method to fabricate tubing on site and preferably from self expanding components that can be continuously fed into a machine to form a tubular shape from overlapping c-shaped segments with offset open regions while securing the tubular shape preferably with an intermediate binder and more preferably a reactive nano-foil. The tubular can be formed to the desired end dimension and then at the surface it can be reconfigured to a lower profile for insertion into a subterranean location. In one option the tubular shape can be retained and the diameter is simply reduced while in other configuration the tubular rounded shape can be reformed into a crescent or other wavy cross-section that allows the insertion of the collapsed shape to the desired location where a stimulus can be provided to cause the self expanding material to revert to the original and enlarged diameter so that greater throughput can occur when production or injection is initiated. These and other aspects of the present invention will be more readily apparent to those skilled in the art by a review of the description of the preferred embodiment and the associated drawings while recognizing that the full scope of the invention is to be determined by the appended claims.

### SUMMARY OF THE INVENTION

Tubular is manufactured at a well site to a predetermined size using flat stock that is rolled into a c-shape from a plurality of feed locations. The c-shapes have open segments that are offset from each other to form the tubular shape. A binder material such as a reactive nano-foil is applied on assembly as the tubular shape is formed. The manufactured shape is reduced to a smaller dimension for run in. The cross-sectional reduced profile shape can be a smaller diameter or a crescent or an undulating shape that is triggered to revert to the original manufactured shape and size when placed downhole. The manufacturing method is capable of making continuous pipe for the length of the zone without connections. The bonding of the segments is preferably done at the time of fabrication at the well site but can also, at least in part, occur downhole.

### BRIEF DESCRIPTION OF THE DRAWINGS

FIG. 1 illustrates the onsite continuous fabrication of the tubular and schematically illustrates changing its manufactured shape to a lower profile shape for running into a subterranean location;

FIG. 2 is the view along line 2-2 of FIG. 1; and

FIG. 3 is the view along line 3-3 of FIG. 1.

### DETAILED DESCRIPTION OF THE PREFERRED EMBODIMENT

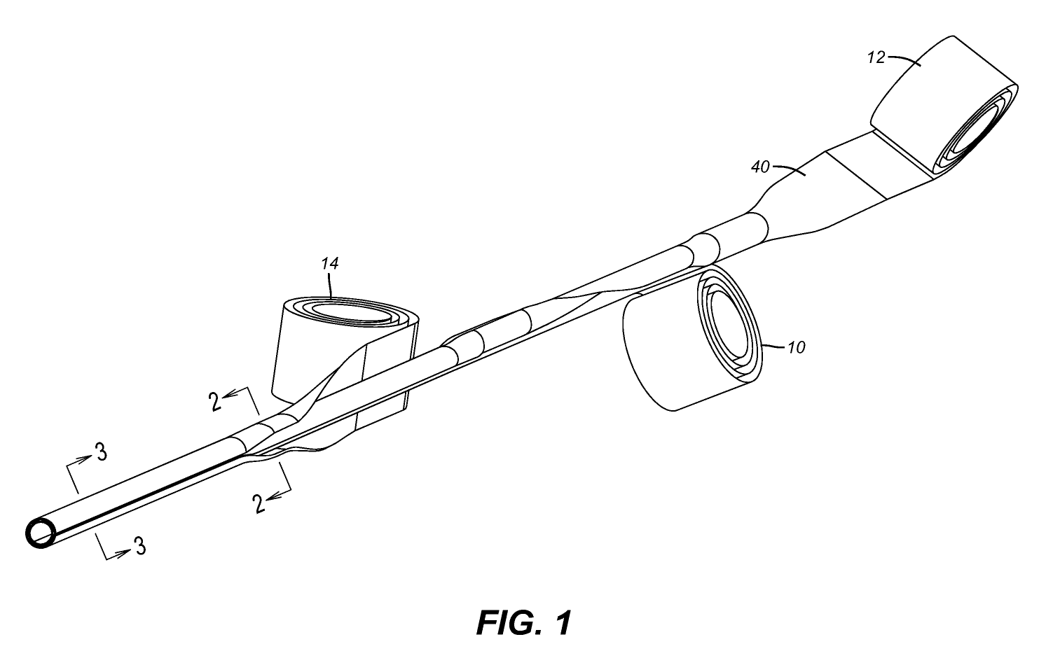

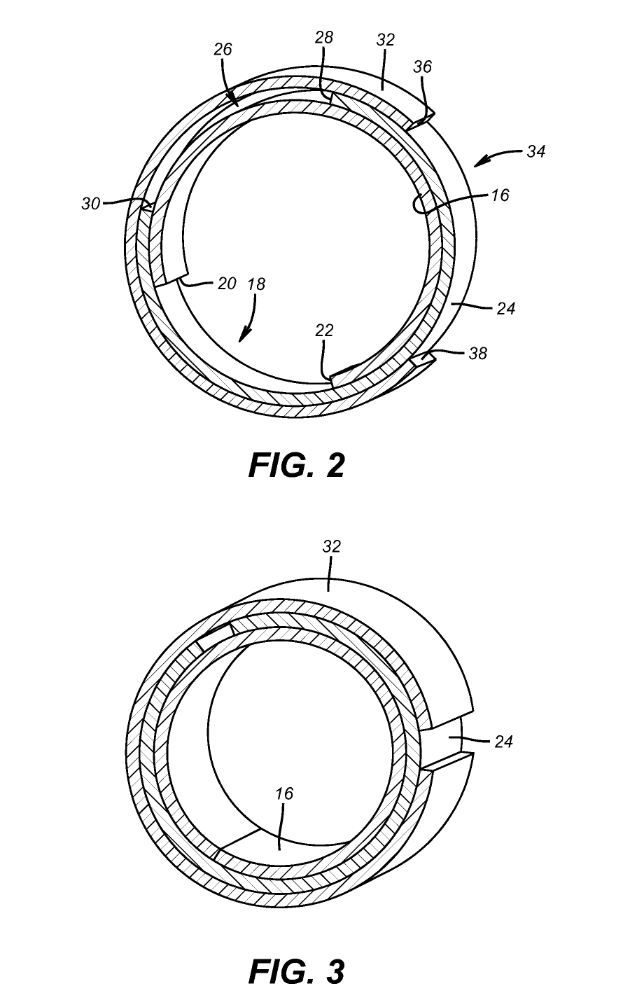

FIG. 1 illustrates flat stock rolls 10, 12 and 14 shown offset at preferably 120 degrees that are to be each rolled into a c-shape better seen in FIGS. 2 and 3 by a machine that is well known in the art and omitted from the FIG. to better appreciate the manufacturing process. The circumferentially offset feeding of the flat stock from rolls 10, 12 and 14 combined with rolling each flat piece into an open circular c-shape with the gaps offset results in making a tube shape as seen in FIGS. 2 and 3. Referring to FIG. 2 which is the initially manufactured configuration, segment 16 comes from roll 12 and has a gap 18 defined between sides 20 and 22. Overlayed on segment 16 is segment 24 that has a gap 26 defined by sides 28 and 30. Finally, segment 32 has a gap 34 defined by sides 36 and 38. Because of the offset feeding shown in FIG. 1 the gaps 18, 26 and 34 are offset preferably by 120 degrees.

While the formed tubular in its largest dimension is illustrated in FIG. 2 as made up from three rolls of flat stock those skilled in the art will appreciate that two or more feed rolls of flat stock could be used without departing from the invention. While the rolls 10, 12 and 14 are shown to have a finite length so that they can be transported over the road on a truck, the process can be stopped as the feed rolls play out into the machine so that the end of a given roll can be extended by securing the beginning of another roll to it. In this manner the process allows for the creation of a continuous tube with no connections for the length of a given zone. While the flat stock is shown as unperforated so that the tube manufactured can convey fluid under pressure without leakage through the wall, in some applications the flat stock on the rolls 10, 12 and 14 can have openings of various shapes, sizes or patterns so that the end result functions as a slotted liner or a liner with apertures for applications such as producing in an open hole completion.

In the preferred embodiment, each of the rolls of flat stock 10, 12 and 14 has a coating 40 on at least the side that will contact another segment. That coating 40 can be preferably a nano-foil or an adhesive or a bonding agent that is preferably activated during the assembly process to bind the segments 16, 24 and 32 together before running into a subterranean location. An adhesive can at least partially set up when the tube shape is fabricated and continue to achieve full strength when run in. Alternatively, well conditions such as temperature or pressure or well fluid properties can act with the bonding agent to initiate or complete the bonding of the segments that form the tube shape.

In the preferred embodiment the flat stock on rolls 10, 12 and 14 is a self expanding material such that when the tube is produced to the larger diameter, as in FIG. 2 it can be worked into a lower profile configuration as in FIG. 3 for example. To get from the FIG. 2 to the FIG. 3 position the machine simply has a die through which the round shape is advanced to reduce its diameter. The self expanding segments then hold that smaller diameter until the string is in place in a subterranean location and a stimulus such as internal pressure is applied with the string in position causing it to revert to the original manufactured diameter of FIG. 2. While the round shape of FIG. 3 can be used as the lower profile configuration of the tubular, the round shape in section can be reduced in profile by folding the tubular on itself in a generally C or a U shape or more complex lower profile shapes such as an undulating configuration.

In another variation, the binder or coating 40 can be eliminated and the segments secured to each other by compaction against each other such as by running the assembly in FIG. 2 through a die on the exterior and a mandrel on the interior that has the result of forcing the segments together as they become a cohesive whole. The segments can still be a self expanding material since the outside dimension can be further reduced after the segments are joined by a compaction process. In so doing, the resulting shape can be run into a smaller drift and then a stimulus applied downhole such as internal pressure or a physical force to have the joined segments revert to the original larger and preferably rounded shape in place in a subterranean location.

Another option that is less preferred is to seal weld segment 32 at ends 36 and 38 to the exposed portions of segment 24 to hold the assembly together on assembly. The segments can still be self expanding to allow a smaller run in dimension and a reversion to the originally manufactured dimension once stimulated to do so downhole.

Another option is to produce the tubular string on location and reduce its profile and then reform it with a swage. In this variation the segments need not be self expanding but they can be and the movement of the swage can be the triggering event for the reversion to the original shape. The original shape can be as large as or even larger than the diameter of the swage.

The advantages of the method and the produced tubular from the method should now be apparent to those skilled in the art. The tubing is produced on site from flat bar that is rolled into a rounded shape. The shapes are preferably open c-shaped segments that overlap with offsetting gaps. In one variation the segments are self expanding and are reformed after being produced into a smaller profile for running in and then when in position are stimulated to revert to the original and larger profile so as to increase flow and decrease resistance to flow of production or injection through them. In another variation the tubular string produced can have openings to function akin to a slotted liner for example.

The segments can be secured to each other with a nano-foil or an adhesive or welding or simply forcing the segments together through a die so that they become a cohesive whole. The number of layers of segments can be varied and the tubular produced can be made on site of a continuous length by simply adding more flat stock to an end of a given roll and continuing the fabrication process. In this way an option exists to avoid connections while spanning a zone of interest.

Larger size tubulars that cannot be practically coiled and transported to a site can now be produced on site and run in continuously as produced or at a later time without need for over the road transportation.

The above description is illustrative of the preferred embodiment and many modifications may be made by those skilled in the art without departing from the invention whose scope is to be determined from the literal and equivalent scope of the claims below.

We claim:

1. A method of providing a tubular string for running into a surface opening to a zone of a subterranean location, comprising:
forming a tubular string at the surface opening from sheet;
running said string into position adjacent the zone.

2. The method of claim 1, comprising:
unrolling sheet in a flat condition from at least one roll;
forming said flat sheet into a rounded shape.

3. The method of claim 2, comprising:
unrolling and reforming sheet from a plurality of rolls into rounded segments with gaps;
nesting said segments.

4. The method of claim 3, comprising:
circumferentially offsetting said gaps formed by said nested segments.

5. The method of claim 4, comprising:
locating nano-foil between segments for securing the segments together.

6. The method of claim 4, comprising:
making a plurality of said segments from a self expanding material.

7. The method of claim 1, comprising:
making said string continuous to span the zone.

8. The method of claim 5, comprising:
actuating said nano-foil to bond segments at least in part at the surface opening.

9. The method of claim 4, comprising:
reducing a profile of said string from the as manufactured dimension to allow it to be run to the subterranean location through a smaller drift dimension.

10. The method of claim 9, comprising:
accomplishing said profile reduction by reducing an external diameter from the as manufactured dimension or reforming a tubular shape with one or more folds or an undulating shape.

11. The method of claim 10, comprising:
making a plurality of said segments from a self expanding material;
triggering said string to revert to its as manufactured shape and dimension when placed adjacent said zone.

12. The method of claim 11, comprising:
using internal pressure or a mechanical force to trigger said reverting.

13. The method of claim 4, comprising:
joining said segments together with a bonding agent or by forcibly pressing said segments against each other when in a tubular shape.

14. The method of claim 12, comprising:
using a swage as said mechanical force;
sizing the swage to reform said string to its as manufactured dimension or a larger dimension than said as manufactured dimension.

15. The method of claim 4, comprising:
joining at least the two outermost segment of the produced string to each other with welding.

16. The method of claim 9, comprising:
reforming said string to the as manufactured or a greater dimension with a swage or internal pressure.

17. The method of claim 4, comprising:
joining at least one beginning of a replacement roll to an end of a roll being unwound and reformed so as to continue making said string to a predetermined length without connections.

18. The method of claim 17, comprising:
using a self expanding material in said rolls;
securing adjacent segments with nano-foil, an adhesive or by forcing them against each other.

19. The method of claim 18, comprising:
using three rolls at once to create a string of 3 nested segments.
